(19) United States
(12) Patent Application Publication
(10) Pub. No.: US 2007/0080105 A1
(43) Pub. Date: Apr. 12, 2007

(54) Metal-free combination relief and anti-drain back valves for fluid filters

(75) Inventor: Nishaj Attassery, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/247,313

(22) Filed: Oct. 11, 2005

(51) Int. Cl. B01D 35/00

(52) U.S. Cl. 210/418; 210/130; 210/136

(57) ABSTRACT

An oil filter includes an integrated bypass and anti-drain back valve. The valve is part of a valve assembly that includes a rigid support. The valve is constructed from a flexible material and includes unitary first and second legs that provide the bypass and anti-drain back features. The valve assembly is arranged between a tapping plate and a filter assembly.

### BACKGROUND OF THE INVENTION

This invention relates to a unitary anti-drain back and relief valve that is one part of a two-piece valve assembly.

Oil filters typically include a relief valve and an anti-drain back valve to selectively control the flow of fluid within the oil filter. The relief valve moves from a closed position to an open position when a filter media within the oil filter becomes clogged so that oil flow bypasses the filter media through the open relief valve. The anti-drain back valve is normally open during engine operation to permit oil to flow into the oil filter. The anti-drain back valve closes once the flow of oil to the oil filter has stopped to prevent debris collected in the filter media from exiting the oil filter where it could damage components.

The relief valve and anti-drain back valve are typically two separate components, each having several parts each. For example, the relief valve typically requires a metal stamping and a spring to maintain relief valve opening tolerance requirements. A single molded rubber member is typically used for the anti-drain back valve.

What is needed is an integrated relief valve and anti-drain back valve that utilizes fewer components.

### SUMMARY OF THE INVENTION AND ADVANTAGES

An inventive filter includes a housing having a can and a tapping plate providing an interior cavity. A filter assembly including a filter media is arranged within the interior cavity. A valve assembly is arranged between the tapping plate and the filter assembly. The valve assembly includes a rigid support supporting a flexible valve to provide the inventive two-piece valve assembly. The flexible valve includes first and second legs that extend away from one another. The first leg seals against the rigid support and the second leg seals against the tapping plate when in a closed position. The first and second legs are integrally formed and provide the relief and anti-drain back features. The first and second legs pivot about a base, which also may be provided by the flexible valve, to move from the closed position to bypass and open positions, respectively.

The rigid support is arranged on an end cap of the filter assembly and engages the tapping plate. In one embodiment, the rigid support includes an axial extension that is received within an inner periphery of the end cap. In the example shown, the first leg seals against a flange extending generally radially outward from the rigid support.

Accordingly, the invention provides an integrated relief and anti-drain back valve that uses fewer components.

These and other features of the present invention can be best understood from the following specification and drawings, the following of which is a brief description.

### BRIEF DESCRIPTION OF THE DRAWINGS

FIG. 1 is a cross-sectional view of an oil filter.

FIG. 2 is an enlarged view of a portion of the oil filter shown in FIG. 1.

FIG. 3A is an enlarged cross-sectional view of a valve incorporating the subject invention with a second leg that provides an anti-drain back valve feature in an open position.

FIG. 3B is an enlarged cross-sectional view of the valve with first and second legs providing relief and anti-drain back features in the open position.

### DETAILED DESCRIPTION OF THE PREFERRED EMBODIMENT

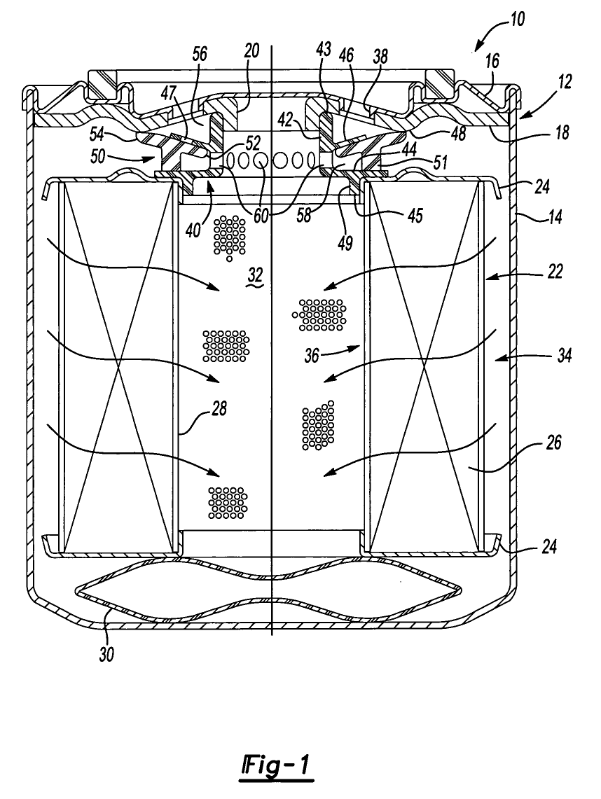

A filter 10, such as those used in oil filter applications, is shown in FIG. 1. The filter 10 includes a housing 12 including a can 14 providing an open end. A retainer 16 and tapping plate 18 are secured at the open end of the housing 12, as is known in the art. The tapping plate 18 includes a threaded central hole 20 that provides an outlet to the filter 10. A filter assembly 22 is arranged within an interior cavity provided by the housing 12. The filter assembly 22 includes spaced apart end discs 24 with a filter media 26 arranged between the end discs 24. The filter media 26 is typically a pleated paper element. The filter media 26 provides a central opening that includes a center tube 28 arranged within the central opening for supporting the filter media 26. A guide 30 is arranged between the can 14 and one of the end discs 24 to locate the filter media 26 within the housing 12 in desired manner, as is known.

The filter media 26 separates the interior cavity into an inlet side 34 and an outlet side 36, which is provided at the central opening 32. Circumferential apertures 38 are arranged in the tapping plate 18 to provide an inlet.

A present invention valve assembly includes a rigid support 40 and a flexible valve 50. The valve 50 provides both relief and anti-drain back valve features. Both the support 40 and valve 50 are generally annular in shape in the examples shown, although other shapes may be used.

The support 40 includes first and second walls 42 and 44 that are arranged transverse to one another. The first wall 42 extends axially from the second wall 44 and terminates in an end portion 43 that engages the tapping plate 18. An axial extension 45 extends from the second wall 44 in a direction generally opposite from the first wall 42. The axial extension 45 provides a shoulder that cooperates with an inner periphery 49 of the end disc 24 to locate the support 40 relative to the end disc 24.

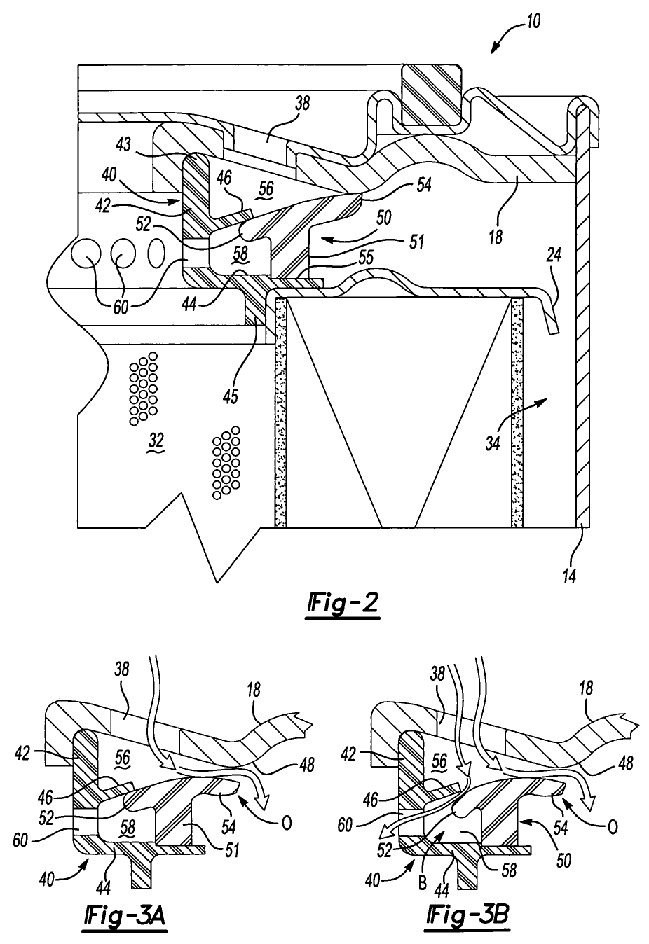

Referring to FIG. 2, the valve 50 includes first and second legs 52 and 54 that extend in opposite directions in the example shown. A base 51 extends transversely from the first and second legs 52 and 54 in a position that is between the terminal ends of the first and second legs 52 and 54. The base and first and second legs 51, 52 and 54 provide a general T-shape when viewed in cross-section as shown in the Figures.

The second wall 44 may include a ledge 55 to radially locate the base 51 on the support 40, as shown in FIGS. 2-3B. Such ledge may not be desired where the first leg 52 extends to engage the first wall 42, as is shown in FIG. 1, since the terminal end of the first leg 52 radially locates the valve 50 relative to the support 40.

The second leg 54 seals against the tapping plate 18 to provide a first cavity 56, as is shown in FIGS. 3A and 3B. The second leg 54 provides the anti-drain back feature, which is normally in the open position O, as shown in FIG. 3A. The second leg 54 engages the tapping plate 18 in a closed position, which is shown in FIG. 1, preventing backflow of oil out of the filter 10 through the apertures 38.

The first leg 52 seals against a flange 46 in the normally closed position, shown in FIG. 1, to direct the flow of oil through the filter media 26. The flange 46 extends generally radially from the first wall 42. In the example shown in FIG. 1, the flange 46 includes holes 47 to enable the fluid to act on the first leg 52 farther away from the base 51 to reduce the opening force. When the filter media 26 becomes clogged, sufficient force will build in the first cavity 56 to force the first leg 52 away from the flange 46 to a open bypass position B, which is shown in FIG. 3B. The oil flows past the first leg 52 into a second cavity 58 provided by the support 40 and valve 50. The support 40 includes multiple holes 60 arranged circumferentially about the first wall 42 so that oil flows through the support 40 when the second leg 54 is in the open bypass position B to permit direct communication between the circumferential apertures 38 and threaded central hole 20 to bypass the filter media 26.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A filter comprising:
a housing having a can and a tapping plate providing an interior cavity;
a filter assembly including a filter media arranged within the interior cavity;
a valve assembly arranged between the tapping plate and the filter assembly, the valve assembly including a support and a valve arranged on the support, the valve having first and second legs extending away from one another, the first leg sealing against the support and the second leg sealing against the tapping plate in closed positions, the first and second legs pivoting about a base to move from the closed positions to open positions.

2. The filter according to claim 1, wherein a first wall of the support and the second leg in the closed position seal against the tapping plate to provide a first cavity, a plurality of apertures in the tapping plate fluidly connected to the first cavity.

3. The filter according to claim 2, wherein the second leg is on an inlet side of the filter media, the filter assembly adapted for a fluid to enter the filter assembly through the plurality of apertures and pass through the filter media to an outlet side, the outlet side fluidly connected to a threaded central hole in the tapping plate.

4. The filter according to claim 1, wherein the filter assembly includes end caps spaced from one another with the filter media arranged between the end caps, the support seated on one of the end caps.

5. The filter according to claim 4, wherein the support includes a wall supporting the base, the wall having an axial extension extending away from the base and near to an inner periphery of the one of the end caps.

6. The filter according to claim 1, wherein the support includes first and second walls transverse to one another, the first wall having a flange extending radially outwardly in a direction generally the same as the second wall, the first leg sealing against the flange and providing a cavity between the valve and the support.

7. The filter according to claim 6, wherein the support includes a hole fluidly connecting an outlet side of the filter media and the cavity.

8. The filter according to claim 1, wherein the valve is annular in shape and includes a cross-section of a unitary structure having generally a T-shape formed by the first and second legs and the base.

9. The filter according to claim 8, wherein the valve is flexible, the first and second legs moving axially inwardly from the closed positions to the open positions.

10. The filter according to claim 1, wherein the support is constructed of a first material and the valve is constructed from a second material that is more flexible than the first material, the support being generally rigid.

11. The filter according to claim 1, wherein the second leg moves to a respective open position under a first pressure and the first leg moves to a respective open position under a second pressure that is greater than the first pressure.

12. A valve assembly for a filter comprising:
a support including first and second walls arranged transverse to one another, the first wall including a flange extending outward from the first wall and in a direction generally the same as the second wall; and
a valve arranged on the support, the valve having first and second legs extending away from one another, the first leg sealing against the flange in a closed position to form a cavity between the valve and support, the support having a hole fluidly connected to the cavity.

13. The valve assembly according to claim 12, wherein the first wall includes an end portion, the flange spaced axially inward from the end portion with the flange arranged between the end portion and the first leg.

14. The valve assembly according to claim 13, wherein the second wall includes an axial extension protruding in a direction away from the end portion.

15. The valve assembly according to claim 14, wherein the valve includes a base arranged between the first and second legs, the first and second legs deflecting axially relative to the base.

16. The valve assembly according to claim 15, wherein the valve is annular in shape and includes a cross-section of a unitary structure having generally a T-shape formed by the first and second legs and the base.

17. The valve assembly according to claim 16, wherein the second wall includes a depression providing a ledge radially locating the base on the support.

18. The valve assembly comprising a flexible valve that is annular in shape having generally a T-shaped cross-section, the flexible valve having a base mounted on a support and a first leg sealing against the support in a closed position to form a cavity, a hole in the support in fluid communication with the cavity.

19. The valve assembly according to claim 18, wherein the support includes first and second walls with the base mounted on the second wall, the first wall includes a flange extending outward in a direction generally the same as the second wall, the first leg sealing against the flange in the closed position.

20. The valve assembly according to claim 19, wherein the flange includes a hole blocked by the first leg in the closed position.
